(19) United States
(12) Patent Application Publication
(10) Pub. No.: US 2003/0031926 A1
(43) Pub. Date: Feb. 13, 2003

(54) Tab surface treatments for polymer-metal laminate electrochemical cell packages

(75) Inventors: Joseph C. Farmer, Tracy, CA (US); Hongpeng Wang, Livermore, CA (US); Gowri S. Nagarajan, Pleasanton, CA (US)

Correspondence Address: BEYER WEAVER & THOMAS LLP, P.O. BOX 778, BERKELEY, CA, 94704-0778, US

(73) Assignee: PolyStor Corporation

(21) Appl. No.: 10/171,509

(22) Filed: Jun. 13, 2002

Related U.S. Application Data
(60) Provisional application No. 60/298,335, filed on Jun. 13, 2001.
(60) Provisional application No. 60/330,734, filed on Oct. 24, 2001.

(51) Int. Cl. H01M 2/02; H01M 2/08; H01M 2/26; H01M 4/66

(52) U.S. Cl. 429/176; 429/231.95; 429/161; 29/623.2; 429/181; 429/245

(57) ABSTRACT

Provided are alternative fabrication methods and compositions for an electrochemical cell. The methods of the present invention are applicable to the manufacture of polymer-cased lithium-ion secondary battery cells. Briefly, electrochemical cell fabrication techniques and articles that enhance the adhesion of polymer-metal laminate packaging materials and components to conductive leads (tabs) to thereby provide a reliable hermetic seal are provided. The tab surface treatments include chromate conversion coatings, phosphate conversion coatings, anodization, and surface cleaning.

### CROSS-REFERENCE TO RELATED APPLICATIONS

This application claims priority to U.S. Provisional Patent Application Serial No. 60/298,335, filed Jun. 13, 2001, and entitled TAB SURFACE COATING FOR POLYMER-METAL LAMINATE ELECTROCHEMICAL CELL PACKAGES, and to U.S. Provisional Patent Application Serial No. 60/330,734 filed Oct. 24, 2001, and entitled TAB SURFACE TREATMENTS FOR POLYMER-METAL LAMINATE ELECTROCHEMICAL CELL PACKAGES, the disclosures of which are incorporated by reference herein in their entirety and for all purposes.

### BACKGROUND OF THE INVENTION

1. Field of the Invention

The present invention relates to electrochemical energy storage devices (electrochemical cells). More particularly, the invention relates to techniques and structures for improving the integrity of the closure seal of a polymer-metal laminate electrochemical cell package at the cell's electrical feed-through tabs.

2. Description of Related Art

Due to the increasing demand for battery-powered electronic equipment, there has been a corresponding increase in demand for rechargeable electrochemical cells having high specific energies. In order to meet this demand, various types of rechargeable cells have been developed, including improved aqueous nickel-cadmium batteries, various formulations of aqueous nickel-metal hydride batteries, nonaqueous rechargeable lithium-metal cells and nonaqueous rechargeable lithium-ion cells.

Lithium-ion cells (sometimes referred to as “lithium rocking chair,” or “lithium intercalation” cells) are attractive because they preserve much of the high cell-voltage and high specific-energy characteristics of lithium-metal cells without poor cycle life, discharge rate, and safety characteristics historically associated with lithium-metal cells. Because of their superior performance characteristics in a number of areas, they quickly gained acceptance in portable electronics applications following their introduction in the early 1990's. Lithium-ion cells retain their charge considerably longer than comparable nickel-cadmium (NiCad) cells and are significantly smaller, both of which are desirable characteristics since manufacturers seek to make electronic products smaller and portable.

Battery cells are primarily composed of a positive electrode, a negative electrode, an ion-conducting separator interposed between the two electrodes, and an electrolyte, which may be in the solid, gel or most commonly, liquid state. Conventional cells have typically been enclosed in a rigid case, typically made of stainless steel, in order to apply pressure to the cell components to maintain good electrical connections between the components. In order to reduce the size and weight of battery cells, more recently attempts have been made to develop battery cells which do not require the rigid case in order to maintain good electrical connections between the battery cell's components. Instead of rigid cell casings, cell designs have been developed using polymer-metal laminate packages.

A problem encountered with these polymer-metal laminate packaged cells is a poor seal at the interface between the polymer packaging material and the conductive leads (also referred to as tabs), particularly those composed of aluminum (generally the positive leads (tabs)), that feed through a seam in the package to provide for external electrical connection. The poor seal may allow for electrolyte to leak out of the cell or air and/or water vapor to enter the cell and causing undesirable reactions that give rise to negative effects such as cell bulging and corrosion of the metal component (e.g., aluminum) of the laminate package.

Thus, processes and materials for providing a reliable hermetic seal at the package-lead interface for a polymer-metal laminate electrochemical cell package would be desirable.

### SUMMARY OF THE INVENTION

To achieve the foregoing, the present invention provides electrochemical cell fabrication techniques and articles that enhance the adhesion of polymer-metal laminate packaging materials and components to conductive leads (tabs) to thereby provide a reliable hermetic seal. In particular embodiments, the adhesion of polymer laminate packaging and components to aluminum leads (tabs) is improved by application of a chromate conversion coating, phosphate conversion coating, anodized coating or by tab surface cleaning.

In various aspects, the invention pertains to methods of treating battery cell lead materials to increase their hydrophobicity and/or enhance their adhesion to polymer metal laminate packaging materials and components to thereby provide a reliable hermetic seal.

For example, in one aspect, the invention pertains to a method of making an electrochemical cell. The method involves preparing a conductive metal lead including surface-treating a metal lead material to increase at least one of hydrophobicity and polymer adhesion of the lead material surfaces, preparing an electrochemical cell structure having the surface-treated conductive lead connected to an electrode and projecting from the structure, and placing the electrochemical cell structure in a polymer-metal laminate cell package with the lead projecting from an opening in the package. Polymeric spacers are optionally interposed between the lead and the polymer-metal laminate cell package. The electrochemical structure is then sealed in the polymer-metal laminate package, whereby a hermetic seal between the electrochemical cell polymer-metal laminate packaging material, optional spacer, and surface-treated lead protruding from the package is formed. In one specific embodiment, the cell is a lithium ion battery cell, the lead material is aluminum, the polymer-metal laminate package includes a sheet of aluminum foil between sheets of polyolefin, spacers composed of cross-linked polypropylene are used, and the metal lead surface-treatment involves the formation of a chromate conversion coating.

Such treated tabs and electrochemical cells incorporating such treated tabs are also provided.

These and other features and advantages of the present invention are described below with reference to the drawings.

### BRIEF DESCRIPTION OF THE DRAWINGS

FIG. 1 depicts a cross-sectional view of a portion of a single laminate layer of an electrochemical structure as in accordance with the present invention.

FIGS. 2A and 2B depict cross-sectional views of basic jellyroll and stacked electrochemical structures for cells in accordance with the present invention.

FIG. 3 depicts a plan view of a completed battery cell in accordance with the present invention.

FIG. 4 depicts a positive current collector structure including a lead in accordance with one embodiment of the present invention.

FIG. 5 is a cross-section of a portion of an electrochemical cell in accordance with one embodiment of the present invention 500 focusing on the seal at the positive (aluminum) lead.

FIG. 6 depicts a process flow for application of a chromate conversion coating to an aluminum lead material in accordance with one embodiment of the present invention.

FIGS. 7A-C depict a process flows for application of a phosphate conversion coating to a lead material in accordance with embodiments of the present invention.

FIG. 8 depicts a process flow for anodizing an aluminum lead material in accordance with one embodiment of the present invention.

FIG. 9 depicts a process flow for surface cleaning an aluminum lead material in accordance with one embodiment of the present invention.

FIG. 10 depicts a flow chart presenting aspects of the sealing of an electrochemical cell in accordance with one embodiment of the present invention.

FIGS. 11A-B depict a graphs showing results of peel strength testing of untreated and treated aluminum tab materials in accordance with the present invention.

### DETAILED DESCRIPTION OF SPECIFIC EMBODIMENTS

Reference will now be made in detail to specific embodiments of the invention. Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

When used in combination with “comprising,” “a method comprising,” “a device comprising” or similar language in this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

The present invention provides electrochemical cell fabrication techniques and articles that enhance the adhesion of polymer-metal laminate packaging materials and components to conductive leads (tabs) to thereby provide a reliable hermetic seal. The adhesion of polymer laminate packaging and components to aluminum leads (tabs) is improved by treatment of tab materials to increase their hydrophobicity. Tab materials with hydrophobic surfaces in accordance with the present invention form a reliable hermetic seal to the surface polymers, typically cross-linked polyalkylenes, in polymer metal laminate packaging materials used in lightweight, flexible electrochemical cells, such as batteries and capacitors. In various embodiments of the invention, the increased hydrophobicity is achieved by to application of a chromate or phosphate conversion coating to tab material; anodizing tab material; or chemically cleaning tab material.

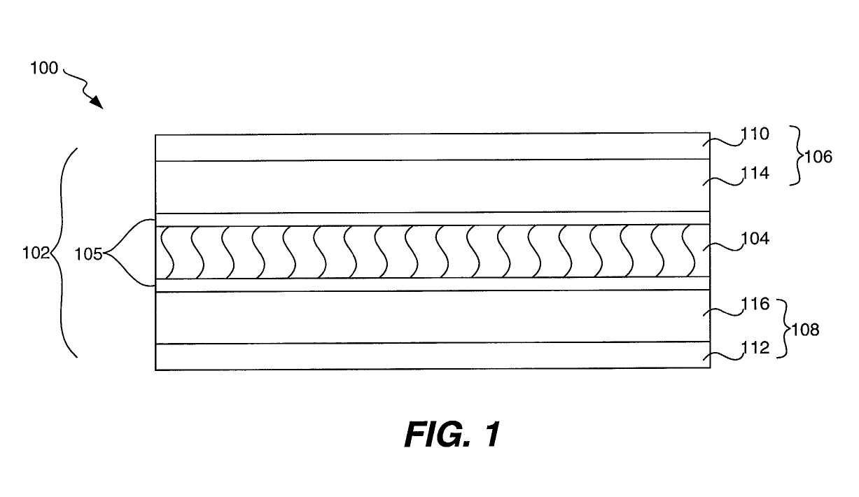

Treated leads in accordance with the present invention may be advantageously incorporated into electrochemical cell structures to be packaged in polymer-metal laminate housings. Referring to FIG. 1, a portion 100 of a single laminate layer 102 of an electrochemical structure suitable for use in conjunction with treated leads in accordance with one embodiment of the present invention is illustrated. As further described below, the electrochemical structure is typically in the form of jellyroll (wound laminate) or stack. The layer 102 includes a porous separator 104 interposed between a positive electrode 106 and a negative electrode 108. The separator is coated with a binder 105 to enhance the bonding of the structure's components to each other. The electrodes 106, 108 are typically formed on current collectors 110, 112, respectively, which may be composed of a highly conductive metal, such as copper or aluminum. For example, the positive electrode 106 may be composed of a cathode material 114 on an aluminum foil current collector 110, and the negative electrode 108 may be composed of an anode material 116 on a copper foil current collector 112.

The components of the electrochemical structure may be composed of appropriate materials known to those of skill in the art. Suitable materials for a lithium-ion cell include, for example, for the positive electrode, carbon (as an electronic conductor), active material (e.g., lithium cobalt oxide, lithium manganese oxide, lithium nickel cobalt oxide, or lithium nickel oxide), and a binder, and for the negative electrode, either carbon or intermetallic alloy or a combination of both as active material with a binder. The binder may be PVDF specifically selected for its physical and chemical properties, in particular its high crystallinity. As noted above, the electrodes are typically formed on current collectors, which may be composed of a highly conductive metal, such as copper or aluminum. The separator may be composed of a porous polyolefin, preferably polyethylene, polypropylene, or a combination of the two, coated as described below. Other possible separator materials include polytetrafuoroethylene, polystryrene, polyethyleneterphtalate, ethylenepropylene diene monomer (EPDM), nylon and combinations thereof. The separator is typically filled with a liquid electrolyte composed of a solvent and a lithium salt. Sample liquid electrolyte compositions for lithium ion cells may include solvents such as propylene carbonate, ethylene carbonate, diethyl carbonate, dimethyl carbonate, dipropyl carbonate, dimethyl sulfoxide, acetonitrile, gamma butyrolactone (GB) and combinations thereof, a lithium salt having Li⁺ as the cation and one of PF₆⁻, AsF₆⁻, BF₄⁻, ClO₄⁻, CF₃SO₃⁻, N(CF₃SO₂)₂⁻ or lithium bis [perfluro-ethyl-sulfonyl] imide (BETI) as the anion.

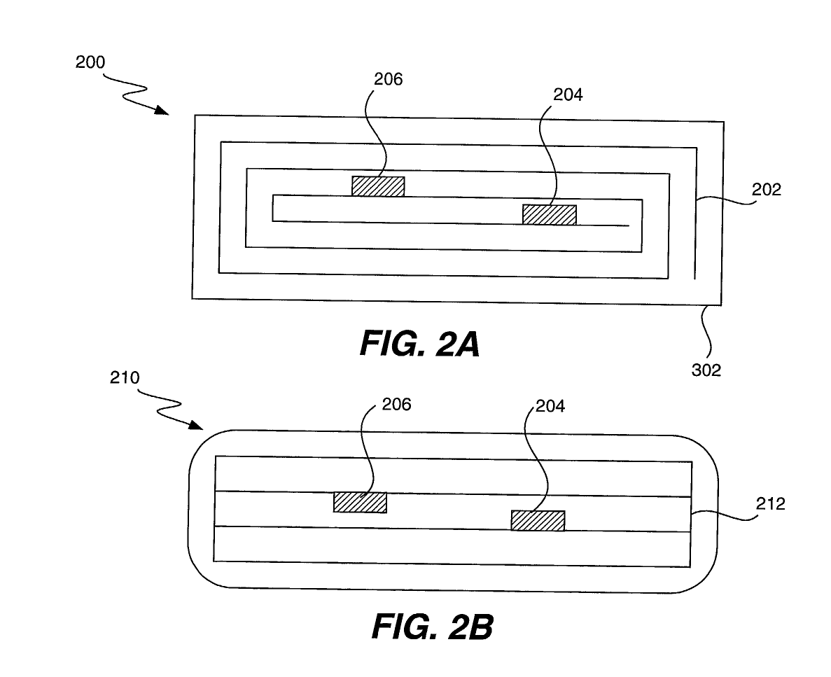

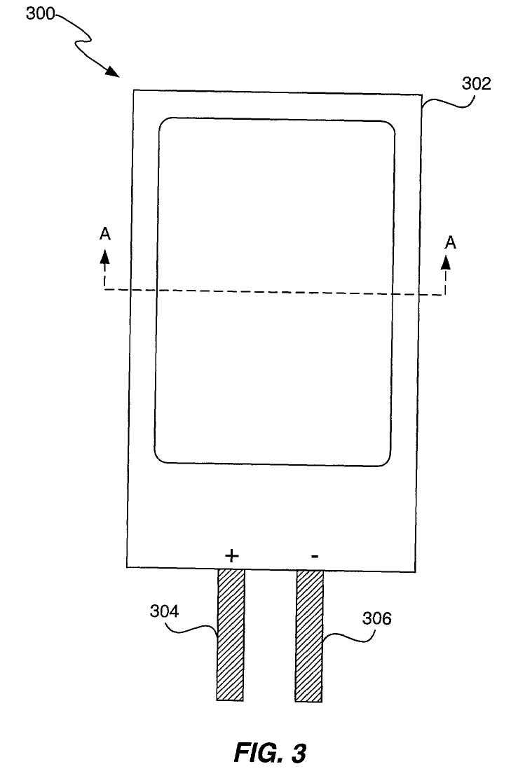

As noted above, an electrochemical structure for a cell in accordance with the present invention is typically in the form of a “jellyroll” (wound laminate) or stack. FIGS. 2A and 2B illustrate basic jellyroll and stacked electrochemical structures for cells in accordance with the present invention. FIG. 2A depicts an enlarged cross-sectional view of a cell (along the line A-A, FIG. 3) depicting a jellyroll structure 200. The jellyroll design 200 is formed by winding a laminate layer 202. FIG. 2B depicts an enlarged cross-sectional view of a cell (along the line A-A, FIG. 3) depicting a stacked structure 210. The stack 210 may be formed by stacking a series of laminate layers 212. In each case, a positive lead 204, often composed of aluminum, is attached, e.g., by welding, to a portion of the positive electrode's current collector, often composed of aluminum, and a negative lead 206, often composed of nickel, is attached to a portion of the negative electrode's current collector, often composed of copper. Winding, stacking, and associated fabrication techniques for cells described herein are well known to those skill in the art.

The electrochemical structure is laminated following addition of the electrolyte and sealing. Lamination of the electrodes and separator may be conducted according to any suitable method known in the art, and may take place either before or after the cell is sealed in its container. Lamination may use, for example, a first press at about 90 psi and 100° C. for about 1 minute, followed by a second 90 psi press for about 1 minute at room temperature in packaging with electrolyte.

Referring to FIG. 3, in a completed battery cell in accordance with the present invention 300, an electrochemical structure such as described above is packaged in a cell container 302 composed of a substantially gas-impermeable barrier material composed a polymer-laminated metal material that is lightweight and flexible. Such cell container materials are well known in the art for use in packaging gel-polymer as well as solid state polymer cell batteries. A particularly preferred cell container material is a polymer-laminated aluminum foil, such as the product referred to as Forming Type Laminated Aluminum Foil for Lithium Ion Battery Application available from Showa Aluminum Corporation, Japan. This product is a laminate approximately 120 microns thick composed of a thin (about 45 microns) aluminum foil between polymer film layers of cross-linked polypropylene (about 45 microns) and nylon (about 30 microns). The polymer film exposed to the interior of the cell (that is, the polymer film that is involved in the cell's seal) is the cross-linked polypropylene. Other polyolefins, for example cross-linked polyethylene, may also be suitable.

Leads 304, 306 connected to each of the positive and negative electrodes of the cell (via their respective current collectors) as described above, extend from the sealed cell container 302 through the cell package and outside the cell for external electrical connection. As described in further detail below, in accordance with one embodiment of the present invention at least the portion of the aluminum (positive) lead surface contacting the polymer of the cell package is treated to improve the adhesion between the lead and the and the polymer-laminate package in the sealed cell.

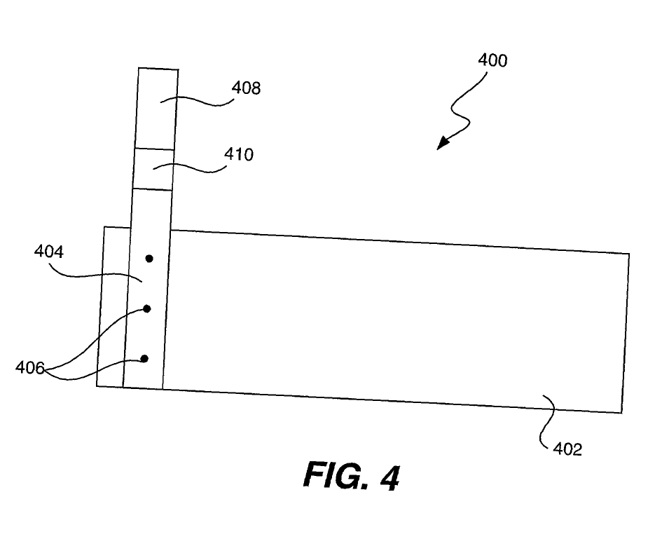

Referring to FIG. 4, a current collector structure 400 including a lead is shown prior to incorporation (winding or stacking) in an electrochemical structure for a cell. The current collector structure is composed of a metal foil current collector 402 with a conductive lead 404 physically and electrically connected at one end. As noted above, typical current collectors may be aluminum foil for positive electrodes and copper foil for negative electrodes, with aluminum and nickel leads, respectively. It should be understood that the invention is applicable to conductive leads generally, whether they are composed of all metal or metal coated on a non-metallic substrate. The lead may be connected by spot welds 406 according to procedures well known in the art. A portion 408 of the lead extends off the current collector. This portion 408 of the lead will extend through the packaging of an electrochemical cell in which the current collector structure 400 is incorporated for external electrical connection. A further portion 410 of the lead 408 will contact the packaging material in the sealed cell. As noted above, the entire lead 404, or just a portion of the lead for example portion 408 or 410, may be treated to enhance the adhesion of the packaging material to the aluminum tab.

General sealing techniques suitable for use in connection with the present invention are also known. Sealing may be accomplished by pressing open edges of the package under such conditions that the polymer material of the polymer-laminated packaging material is bonded to itself and to the positive and negative leads (tabs) that traverse the seal. For a polyolefin(s) (e.g., polyethylene, polypropylene, etc.) in the package laminate, suitable sealing parameters are to press at about 30 psi and 175° C. for about 4 seconds, for example, in a Sencorp Sealing Machine (Model #12ASL/1) available from DT Industries, Sencorp Systems Inc., Hyannis, Mass. Where the leads pass through the package seal, small plastic spacers may be interposed between the packaging material and the leads to provide an additional insulating barrier between the lead and the metal in the laminate packaging material.

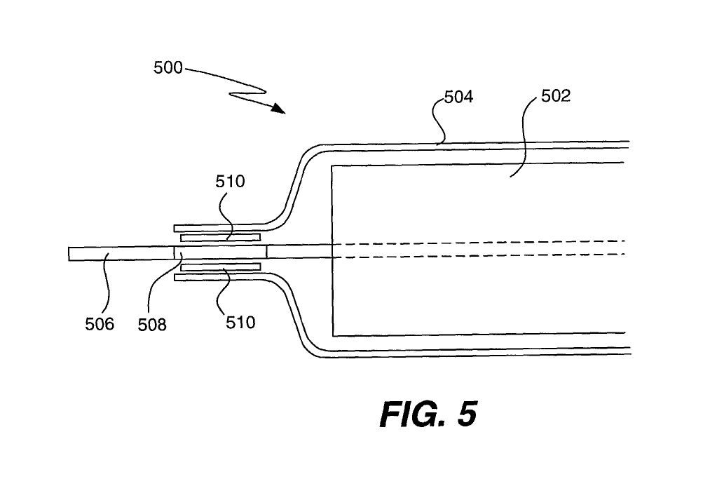

FIG. 5 is a cross-section of a portion of an electrochemical cell in accordance with one embodiment of the present invention 500 focusing on the seal at the positive (aluminum) lead. An electrochemical structure 502, such as that described above for a lithium ion cell, is enclosed by a polymer-metal laminate cell container 504, such as described above. The cell's positive lead (tab) 506 extends from the electrochemical structure 502, through a seam in the polymer-metal laminate cell container 504 and outside the cell for external electrical connection. In accordance with the present invention, the lead 506 is treated to enhance its surface adhesion to the outer polymer layer of the polymer-metal laminate cell container 504. The surface treatment may be along the entire length of the lead, or may just cover a portion of the lead as long as it is present on that potion 508 of the lead involved in the seal.

Spacers 510 may be interposed between the packaging material 504 and the lead 506. A suitable spacer is composed of an electrically insulating material to provide an additional insulating barrier between the lead and the metal in the laminate packaging material and provide good adhesion of the lead to the packaging material. It may be of any suitable thickness, for example, about 50 to 200 microns thick. Suitable materials include polyolefins. Examples include cross-linked polypropylene (CPP) or polyethylene with melting points ranging from about 130 to 175° C. One such material, 100 micron thick CPP, is available from Showa Aluminum Company, Japan. The cell container may then be sealed, for example as described above. It should be understood that the spacers, while used in accordance with the specific embodiment illustrated in FIG. 5, are an optional feature of a cell in accordance with the present invention. In other embodiments, in may be possible to use a packaging material having a sufficiently thick layer of interior polymer in the packaging material composite to avoid shorting of the lead to the package metal upon sealing.

As noted above, the adhesion of polymer laminate packaging and components to aluminum leads (tabs) is improved by treatment of tab materials to increase their hydrophobicity. Tab materials with hydrophobic surfaces in accordance with the present invention form a reliable hermetic seal to the surface polymers, typically cross-linked polyalkylenes, in polymer-metal laminate packaging materials used in lightweight, flexible electrochemical cells, such as batteries and capacitors. In various embodiments of the invention, the increased hydrophobicity is achieved by to application of a chromate or phosphate conversion coatings to tab material; anodizing tab material; or chemically cleaning tab material.

1. Conversion Coatings

Treatment of aluminum leads (tabs) in accordance with the present invention may be conducted by application of a conversion coating, as described below. “Conversion” coatings are formed in place at a substrate metal surface, incorporating metal ions dissolved from the surface. As such, they are integrally bonded to the substrate metal. In this respect, conversion coatings differ from electro-deposited coatings, which are “additive” or superimposed on the substrate metal. Chromate and conversion coatings are well known in the art of metal finishing and are further described in various publications including F. W. Eppensteiner & M. R. Jenkins, Chromate Conversion Coatings, in 46^{th} Metal Finishing Guidebook Directory, N. Hall ed., pp.555-571 (Metals and Plastics Publications, Inc., Hackensack, N.J., 1978). The same publication includes a description of phosphate conversion coatings in the chapter Phosphate Conversion Coatings, which is also incorporated by reference herein.

A. Chromate Conversion Coating

Chromate coating of aluminum leads (tabs) in accordance with the present invention is conducted by application of a chromate conversion coating (also known in the metal finishing industry as alodine coating), for example, as described below. In one embodiment, the chromate coating is applied to that portion of the lead tab to come in contact with the polymer-laminate cell package material when the cell is sealed. Suitable masks may be applied during the chromate coating processing to restrict the conversion coating to that portion of the lead tab. In other embodiments, the chromate coating may cover additional portions or the entire surface of the lead material.

In this instance, the electrical conductivity of chromate coatings in accordance with the present invention is advantageous in that it does not interfere with the connection, generally accomplished by welding in an automated cell winder, of the lead to the current collector. Thus, the chromate coating processes and articles of the present invention are suitable for use in both manual and automated electrochemical cell fabrication. It should also be noted that, in an additional step, a conductive metal strip (e.g., a nickel tip) may be spot welded or ultrasonically welded on to the coated area (even where the coating is not a good conductor) to ensure electrical conduction where needed.

A suitable chromate coating on a conductive (e.g., aluminum) lead in accordance with the present invention is generally referred to in the metal finishing arts as a “chromate conversion coating.” The term “alodine coating” is also used and has variants depending upon treatment conditions (e.g., used the same chemical constituents, but shorter time in bath and different pH results in a “clear alodine coating” rather than a “gold alodine coating;” the properties of the coatings are similar). These coatings can be obtained either chemically or electrochemically using a mixture of hexavalent chromium and certain other compounds resulting in a surface finish that is a complex mixture of chromium compounds. These coatings become hydrophobic, less soluble, abrasion resistant, and corrosion resistant over time. While not limiting the forgoing, the protection is believed to be due both to the corrosion inhibiting effect of hexavalent chromium contained in the film and to the physical barrier presented by the film itself.

A suitable coating thickness is of the order of about a few (e.g., 2-5, such as 3) angstroms, but may vary between a few angstroms and a few tens of angstroms (e.g., 20-30). The thickness of this type of coating is often indicated in the metal finishing arts in terms of the color obtained from the finished coating; the darker the color, the thicker the coating. Chromate coatings on aluminum can vary in color from clear or white through yellow and gold to dark red, depending upon various parameters including the pH of the immersion bath, concentration of the hexavalent chromium in the bath, time of immersion in the bath, and pre-treatments to the metal itself. In one embodiment, an aluminum lead may be immersed in a bath of a solution of hexavalent chromium compounds (e.g., chromium trioxide) at a pH of about 1.3 to 2.0 and a temperature of about 60 to 120 degrees F. (for example, ambient) for about 15 seconds to 6 minutes depending on the thickness of the coating desired. As noted above, the thickness may be determined by color. In one embodiment, the lead may be removed from the solution when it has coated to a thickness having a golden color.

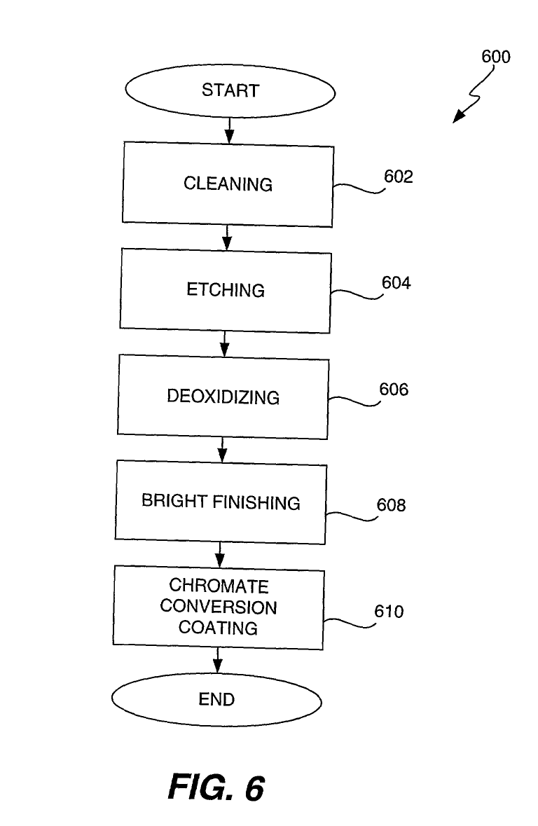

FIG. 6 depicts a process flow for application of a chromate conversion coating to an aluminum lead material in accordance with one embodiment of the present invention. The chromate conversion coating process may also by applied to metals other than aluminum, and, while the invention has been found to be beneficial in connection with aluminum (positive) leads, it my also be beneficially applied to other conductive lead materials. Those skilled in the metal finishing arts will recognize that this process flow incorporates pre-treatments that are preferred but may not be necessary for application of a functional chromate conversion coating and variations in the parameters may also produce acceptable coatings.

Prior to coating, the aluminum lead material is cut into leads. A suitable aluminum material is “dead soft” Al—Type 1145 about 50 to about 200 microns thick, although other aluminum lead materials may also be used. The dimensions of the leads may vary depending on the size and format of the electrochemical cell in which it is to be used and is unimportant for the purposes of application of the chromate conversion coating. The dimensions of a positive lead such as are commonly used in lithium-ion battery cells for portable electronic devices are about 6 cm by 0.5 cm. It should also be noted that the lead material may also have a chromate conversion coating applied prior to being cut into leads.

The aluminum lead is cleaned in a mildly alkaline solution to remove oil, grease, and other foreign material from the surface (602). For example, the lead may be immersed in a solution of sodium dodecylbenzene sulfonate, or other suitable metal cleaning agent, at a temperature of about ambient to 160 degrees for about 30 seconds to 10 minutes. After rinsing in deionized water, the cleaned lead is etched in a strongly alkaline solution to remove light soils and provide a decorative uniform etch on the aluminum surface (604). A suitable etching may be achieved in a bath of concentrated NaOH at about ambient to 160 degrees F. for about 30 seconds to 10 minutes. After rinsing in water, the etched lead is deoxidized to remove smut left by cleaning and/or etching of the aluminum (606). The deoxidizing may be accomplished, for example, by immersion in a solution containing sulfuric acid, iron salts soluble in nitric acid, and fluoroboric acid at pH of about 1 to 1.5 and ambient temperature for about 30 to 120 seconds. Following a further rinse with water, a bright finish treatment is used to remove light oils, moderate to heavy oxides, mill markings, and to prepare the surface for conversion coating (608). For bright finishing, the lead may be immersed in a strong acid bath (for example, hydrofluoric acid or phosphoric acid) for about 1 to 10 minutes at ambient temperature.

After rinsing, the chromate conversion coating may be applied (610). As noted above, depending on the condition of the lead material surface, some or all of the pre-treating procedures described above may not be necessary; pre-treating, however, ensures that the lead surface is properly prepared to receive the chromate coating and is known to result in a high quality coating. A solution of hexavalent chromium compounds (e.g., chromium trioxide), inorganic fluoride (e.g., sodium hexa fluoro silicate), and barium nitrate at a pH of about 1.3 to 2.0 and a temperature of about 60 to 120 degrees F. (for example, ambient) may be applied by brush, spray, or immersion. The time of contact with the chromium solution may be from about 15 seconds to 6 minutes depending on the thickness of the coating desired. As noted above, the thickness may be determined by color. In one embodiment, a golden color indicates a suitable coating thickness. Following coating, the lead is rinsed in water and is then ready for bonding to a current collector for incorporation into an electrochemical structure.

B. Phosphate Conversion Coatings

Phosphate coating of aluminum leads (tabs) in accordance with the present invention is conducted by application of a phosphate conversion coating, for example, as described below. In one embodiment, the phosphate coating is applied to that portion of the lead tab to come in contact with the polymer-laminate cell package material when the cell is sealed. Suitable masks may be applied during the phosphate coating processing to restrict the conversion coating to that portion of the lead tab. In other embodiments, the phosphate coating may cover additional portions or the entire surface of the lead material.

A suitable phosphate coating on a conductive lead in accordance with the present invention is generally referred to in the metal finishing arts as a “phosphate conversion coating.” These coatings are transformations of metal substrates used as tab materials in batteries (particularly aluminum, but other metal such as nickel may also be used) into new surfaces having non-metallic, and non-conductive properties.

Metal phosphate coatings are insoluble in water, but soluble in mineral acids. Thus, phosphating solutions include metal phosphates dissolved in balanced solutions of phosphoric acid. As long as the acid concentration of the bath remains above a critical point, the metal phosphate remains in the solution. When a reactive metal tab material is contacted with (e.g., immersed in) a phosphating solution, light pickling takes place and the acid concentration is reduced at the liquid-metal interface. Metal from the substrate is dissolved, hydrogen is evolved, and a phosphate coating is precipitated on the metal tab material surface.

Phosphate conversion coatings put a battery tab material surface in a water-resistant (hydrophobic), non-alkaline condition and impose relative uniformity in surface texture. They also increase the surface area upon which the systems of attractive forces causing adhesion can act by creating capillaries and micro-cavities and insulate the coated metal tabs against electrochemical corrosion.

Phosphate conversion coatings may be applied to metal tab materials in accordance with the present invention in any suitable manner, including by brush, spray or immersion. In addition, several types of phosphate coatings may be used in accordance with the present invention. Exemplary phosphate conversion coating application techniques for iron, zinc, and manganese phosphate conversion coatings suitable for coating tabs in accordance with the present invention are provided below. Other phosphate coatings as are known by or apparent to one skilled in the art from the present disclosure may also be used.

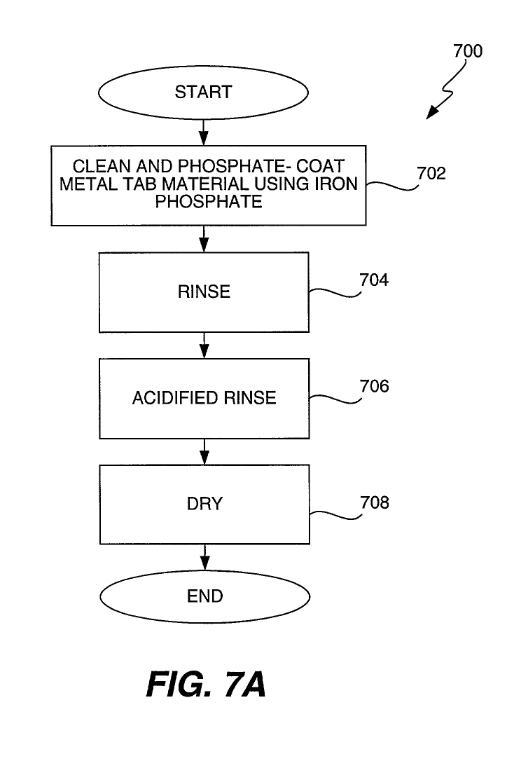

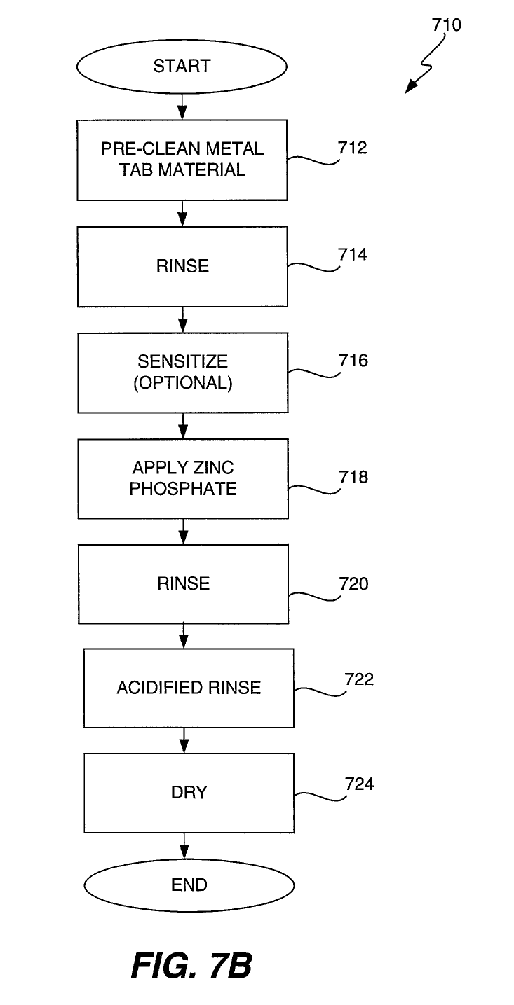

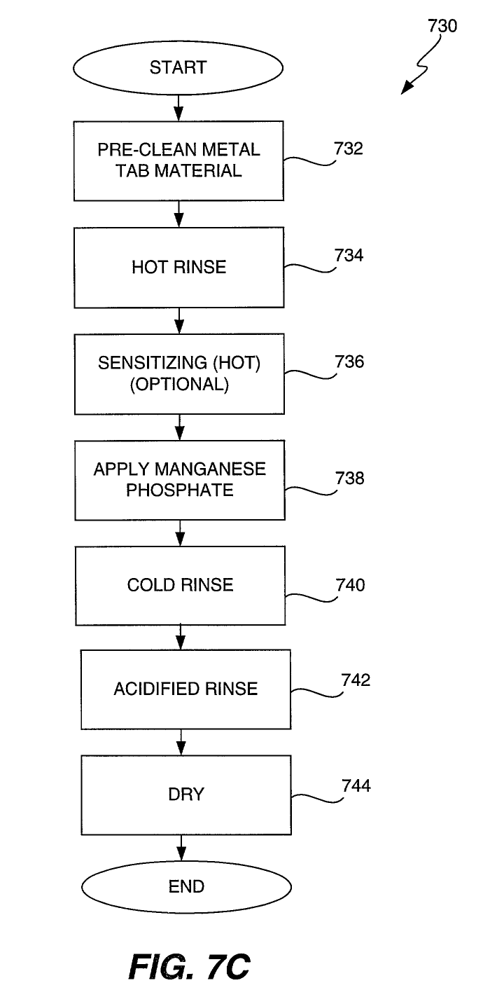

Iron phosphate conversion coatings in accordance with the present invention may be applied according to the procedure illustrated in the process flow 700 of FIG. 7A. A metal tab material, for example, aluminum, is cleaned and phosphated substantially simultaneously (702). The phosphated material is then rinsed with water (704), and treated with an acidified rinse (706) for pollution reduction. The material is then dried (708).

As noted above, the iron phosphate coating may be applied by a variety of techniques. For example, an iron phosphating spray may be used. An iron phosphate solution composed of about 0.5 to 2 oz. of iron phosphate per gallon of water with a pH of about 3.5 to 5.0 may be applied to a tab material by spray at a temperature of about 60 to 160 degrees F. After about 60 to 120 seconds of this cleaning and phosphating treatment, the tab material may be rinsed with water in a re-circulating water bath at about 90 degrees F. for about 20 to 30 seconds. This water rinse is followed by an acidified rinse of about 20 to 30 seconds of about 4 to 12 oz. H₃PO₄ per 100 gallons of water (pH about 3.5 to 5.0) at about 90 to 160 degrees F. The coated material is then dried.

Alternatively, an iron phosphating dip may be used. A tab material may be immersed in an iron phosphate solution composed of about 5% iron phosphate in water with a pH of about 3.5 to 4.5 and a temperature of about 125 to 160 degrees F. for about 3 to 5 minutes. After about 60 to 120 seconds of this cleaning and phosphating treatment, the tab material may be rinsed with water in a re-circulating water bath at about 90 degrees F. for about 20 to 30 seconds. This water rinse is followed by an acidified rinse of about 20 to 30 seconds of about 4 to 12 oz. H₃PO₄ per 100 gallons of water (pH about 3.5 to 5.0) at about 90 to 160 degrees F. The coated material is then dried.

Zinc phosphate conversion coatings in accordance with the present invention may be applied according to the procedure illustrated in the process flow 710 of FIG. 7B. A metal tab material, for example, aluminum, is pre-cleaned (712) and rinsed with water (714). The material is then optionally treated with a sensitizing rinse (716) before being treated with zinc phosphate (718). The phosphated material is then rinsed with water (720), and treated with an acidified rinse (722) for pollution reduction. The material is then dried (724).

In one embodiment, the zinc phosphate may be applied by spray. The pre-clean is conducted by spraying (for example, as above) a tab material with an alkaline solution of about 0.5 to 1 oz. strong base, for example NaOH or KOH, per gallon of water at about 100 to 160 degrees F. After about 30 seconds of this cleaning treatment, the tab material may be rinsed with water in a re-circulating water bath at about 90 degrees F. for about 30 seconds. This water rinse may optionally be followed by a sensitizing rinse of, for example, a titanium activator solution composed of about 1 lb activator per 1000 gallons of water at about 90 degrees F. for about 30 seconds.

Then a zinc phosphate treatment with a solution is applied to the tab material by spray. The phosphating treatment may be for about 60 seconds at a temperature of about 100 to 140 degrees F. using a zinc phosphate solution may be composed of about 2.5% by volume zinc phosphate in water (total to free acid ratio: 13:1 to 20:1). Alternatively, the phosphating treatment may be for about 3 to 5 minutes at a temperature of about 140 to 180 degrees F. using a zinc phosphate solution may be composed of about 4% by volume zinc phosphate in water (total to free acid ratio: 6:1 to 12:1 (“heavy zinc”). After phosphating treatment, the tab material may be rinsed with water in a re-circulating water bath at about 90 degrees F. for about 20 seconds, followed by an acidified rinse of about 20 seconds of about 4 to 12 oz. H₃PO₄ per 100 gallons of water (pH about 3.5 to 5.0) at about 100 to 165 degrees F. The coated material is then dried.

Manganese phosphate conversion coatings in accordance with the present invention may be applied according to the procedure illustrated in the process flow 730 of FIG. 7C. A metal tab material, for example, aluminum, is pre-cleaned (732), preferably with a hot alkaline cleaner, and rinsed with hot (e.g., greater than 100 F.) water (734) (to keep metal hot and accelerate the subsequent phosphating reaction). The material is then optionally treated with a hot sensitizing rinse (736) before being immersed in manganese phosphate solution (about 6 to 10% by volume) at about 200 to 210 degrees F. for about 10 to 30 minutes (738). The phosphated material is then rinsed with cold water (740), and treated with an acidified rinse (742). The material is then dried (744).

As with chromate conversion coatings, a suitable coating thickness for phosphate conversion coatings is on the order of about a few angstroms, but may vary between a few angstroms and a few tens of angstroms.

2. Anodizing

Aluminum battery cell tab material may also be anodized in accordance with the present invention. As is well known in the metal finishing arts, when an aluminum part is made the anode in an electrolytic cell, an oxide film is formed on the aluminum. By utilizing this process, known as anodizing, aluminum can be used in many applications for which it might not otherwise be suitable. The process forms an oxide film, which grows from the base metal and imparts to the aluminum a hard, corrosion and abrasion resistant, coating with excellent wear properties, which can also be colored using a number of methods.

The nature of the film formed is controlled by the electrolyte and anodizing conditions used. If the coating is slightly soluble in the electrolyte, porous films are formed. As the coating grows under the influence of the applied current, it also dissolves and pores develop. Without intending to be limited by theory, it is this property that is believed to result in a stronger bond between the polymer (e.g., CPP) of a battery cell laminate package and the anodized aluminum tab surface relative to an untreated aluminum surface.

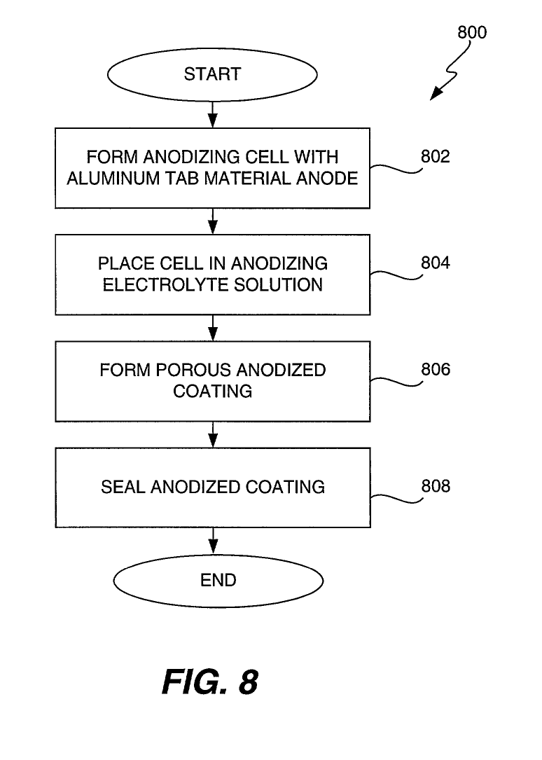

According to one embodiment of the present invention, illustrated in the process flow 800 of FIG. 8, an anodizing cell is formed from an aluminum battery tab material anode paired with a cathode also chosen to be aluminum due to its ability to reduce energy requirements and its high conductivity (802). An anode/cathode ratio of approximately 3:1 is preferred. The anodizing cell electrodes are placed in an anodizing electrolyte solution (804). A typical solution is sulfuric acid about 15 wt/vol % (e.g., 165 g/L). Alternatively, almost any acid solution can be used, including chromic, oxalic and phosphoric acids. In this embodiment, the temperature of the sulfuric acid solution is about 60 to 80 degrees F. and the current density of about 10 to 15 A/ft². The anodized coating is slightly soluble in this sulfuric acid solution providing the conditions for formation of a porous oxide film (806). The duration of treatment is about 12 to 30 minutes depending on film thickness desired.

Once the porous anodized coating is formed, it is sealed to achieve the protective and corrosion resistant properties of the finished tabs (808). The sealing process involves immersing the anodized parts in a solution of boiling water or other solution, such as nickel acetate, wherein the aluminum oxide is hydrated. The treated material is then dried (810).

3. Surface Cleaning

The tab material surface treatments described above particularly enhance adhesion of aluminum tabs to polymer (e.g., CPP) to provide a reliable hermetic seal where the leads exit the polymer-laminate packaged battery cell. It should also be noted that to improve the adhesion of the aluminum tab to CPP, a simpler technique, surface cleaning, than the foregoing may also be used. The bond that is obtained by the use of the previous techniques is generally superior to the one achieved simply by surface cleaning, nevertheless the bond achieved with surface cleaning is significantly greater than that possible with plain, untreated aluminum.

Aluminum commonly used as the positive tab in a lithium ion battery comes from slitting and drawing operations which use machine oil to enable the slitting and the drawing processes without creating too much heat at the blades of the machine. The presence of this oil can potentially result in an imperfect seal in the battery seal flange around the tabs.

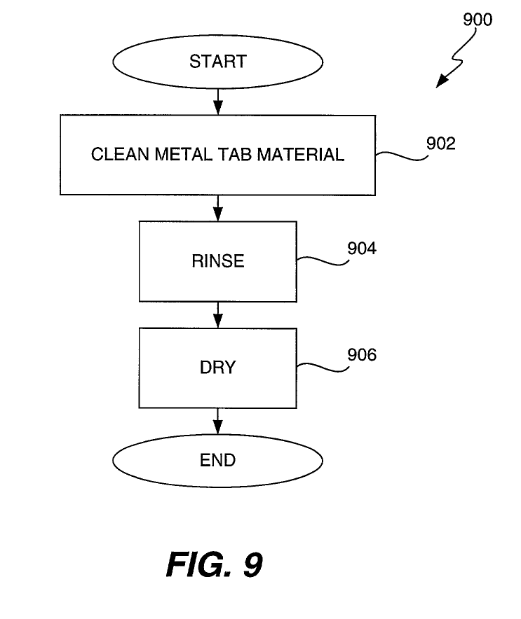

Thus, as illustrated in the process flow 900 of FIG. 9, in another embodiment of the present invention, this oil is removed. Oil removal can be achieved in a number of ways including: acid rinse, caustic rinse, or a combination of both. Suitable cleaning acids are sulfuric acid, phosphoric acid, or gluconic acid. Suitable caustic rinses include highly alkaline salts, such as sodium hydroxide, silicates, and carbonates. In a specific embodiment, sodium hydroxide is the cleaning agent. Cleaning treatment is best done by contacting tab material with cleaning agent at elevated temperatures (e.g., about 120 to 200 degrees F.) at concentrations ranging from about 0.5 to 2 lbs. cleaning agent per gallon of water (902). Cleaning agent may be applied to the to material by spraying, soaking, and/or electrocleaning. The treated material is then rinsed (e.g., with water) (904),and dried (906).

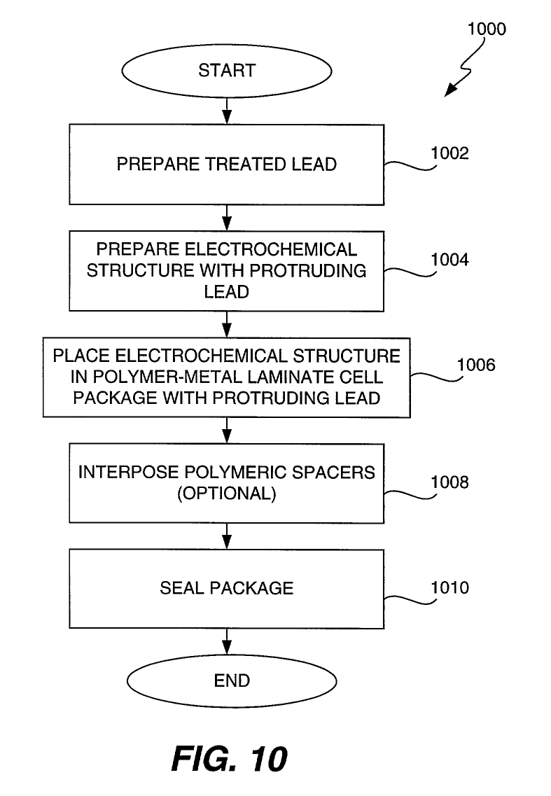

FIG. 10 depicts a flow chart presenting aspects of the sealing of an electrochemical cell in accordance with one embodiment of the present invention. A treated lead is prepared, for example according to the various techniques described above (1002). An electrochemical cell structure is prepared having the treated lead connected to an electrode and projecting from the structure (1004). The electrochemical cell structure is placed in a polymer-metal laminate cell package, with the treated lead projecting from an opening in the package (1006). Polymeric spacers, composed for example of cross-linked polypropylene ((CPP), are interposed between the lead and the polymer-metal laminate cell package where it exits the package (1008) to provide for adequate electrical insulation between the lead and the metal of the package material laminate where the polymer of the laminate is insufficient to provide adequate electrical insulation upon sealing of the package. The spacers may not be necessary in some implementations of the invention. The electrochemical structure is then sealed in the polymer-metal laminate package, for example, as described above (1010). Such a process enables the formation of a hermetic seal between the electrochemical cell polymer-metal laminate packaging material, any spacer, and treated metal leads protruding from the package.

As illustrated in the following examples, surface treated (e.g., chromated) tabs in accordance with the present invention demonstrate improved adhesion to the polymeric constituents of the cell packaging (polymers of the packaging material and, as required, spacers) relative to untreated tabs and result in improved cell seals. Further, the use of chromate coated tabs, for example, has been shown not to result in any detrimental effect on the capacity or fade characteristics of lithium-ion cells in which they are incorporated.

### EXAMPLES

The following examples provide additional experimental details relating to techniques and materials in accordance with the present invention in order to show increased tab adhesion, and improved sealing observed for cells incorporating coated tabs in accordance with the present invention. This material intended to assist in an understanding of the present invention and should not be construed to limit the scope of the invention.

### Example 1

### Peel Strength Test

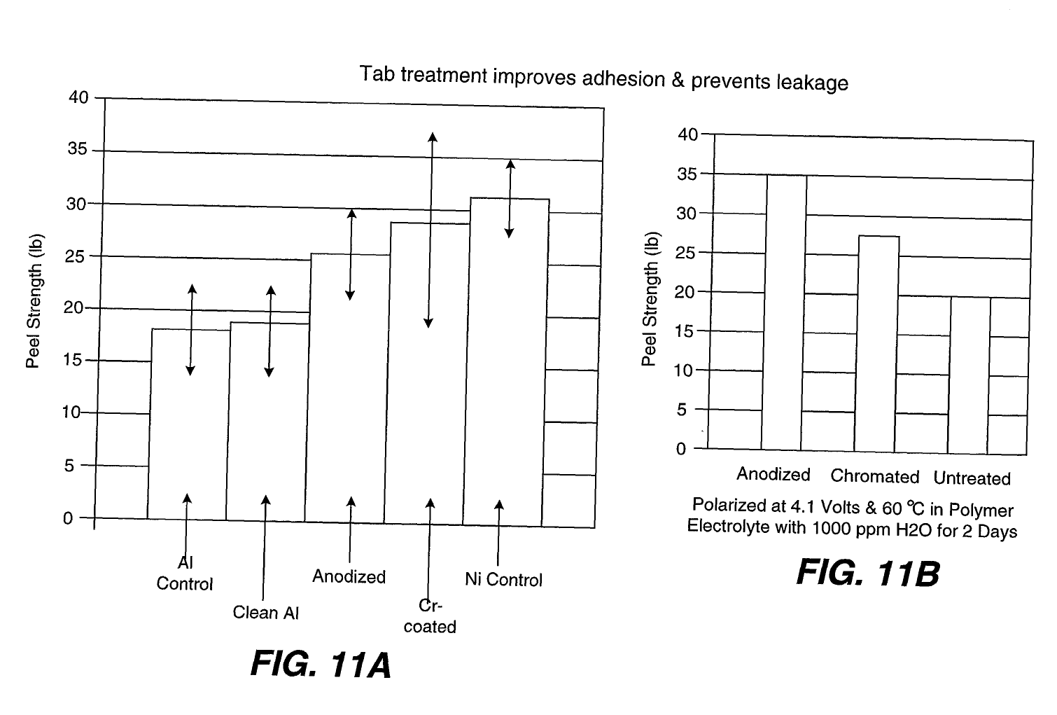

The adhesive strength of the lead/package bond was tested as follows: Samples of treated (chromated, anodized and cleaned) and untreated aluminum foil with thickness of about 2 mils were cut into pieces with dimensions of about 1×1.5 inches. Three layers of a 6 mm wide, 50 micron thick cross-linked polypropylene (CPP) film strip were heat pressed at 350 degrees F., at 5 psi for 30 seconds on the foil samples along the 1 inch side. Polymer-metal composite package films (Forming Type Laminated Aluminum Foil for Lithium Ion Battery Application available from Showa Aluminum Corporation, Japan) used for polymer cells were then heat pressed along the CPP strip on the foil samples. Peel strength measurements (that is, the force required to separate the aluminum foil, CPP and package laminate) were then taken using a tensile tester (Model Number QTEST/1L, manufactured by MTS Systems Corporation, Eden Prairie, Minn. The results, depicted in the graphs of FIGS. 11A and B show that the treated aluminum had significantly higher peel strength than the untreated (Al control) aluminum.

### Example 2

### HTA-Hermetic Test

Chromate conversion coated aluminum strips (Cr—Al tab) were used as positive tabs in lithium-ion polymer (polymer-metal laminate-cased) cells. The sealing properties of the Cr—Al tab were tested using the industry standard HTA method composed of three major steps: 1) store the fully charged polymer cells at 75° C. for 48 hours; 2) store the cell at 75° C. for 48 hours followed immediately by —20° C. thermal shock of the polymer cell for 6 hours; 3) “altitude” test in a negative 26 inches of Hg vacuum for 6 hours. During each step, if the weight loss of the cell is larger than 20 mg, the cells fail the hermetic tests.

Cells made with chromate coated positive aluminum tabs in accordance with the present invention passed HTA testing 100% of the time. In a control experiment, with 100 cells with standard aluminum tabs and 100 cells with chromated tabs, about 5% of cells with standard aluminum tabs leaked at the positive tab. However, none of the cells with chromated tabs leaked.

### CONCLUSION

Surface-treated tab materials in accordance with the present invention have the advantage that they particularly enhance adhesion of aluminum tabs to polymer (e.g., CPP) to provide a reliable hermetic seal where the leads exit the polymer-laminate packaged battery cell.

Although the foregoing invention has been described in some detail for purposes of clarity of understanding, it will be apparent that certain changes and modifications may be practiced within the scope of the appended claims. For example, while the invention is primarily described with reference to aluminum positive lead materials, other metal lead materials may also be advantageously modified by one or more of the surface treatments to achieve the goals of the present invention. Further, other surface treatments that achieve the claimed advantages may also be used, such as silane (siloxane) surface treatment of metal tab materials). It should be noted that there are many alternative ways of implementing both the process and compositions of the present invention. Accordingly, the present embodiments are to be considered as illustrative and not restrictive, and the invention is not to be limited to the details given herein, but may be modified within the scope and equivalents of the appended claims.

It is claimed:

1. A method of making an electrochemical cell, comprising:
preparing a conductive metal lead including surface-treating a metal lead material to increase at least one of hydrophobicity and polymer adhesion of the lead material surfaces;
preparing an electrochemical cell structure having said surface-treated conductive lead connected to an electrode and projecting from said structure;
placing the electrochemical cell structure in a polymer-metal laminate cell package, said lead projecting from an opening in said package;
optionally, interposing polymeric spacers between the lead and the polymer-metal laminate cell package; and
sealing said electrochemical structure in the polymer-metal laminate package, whereby a hermetic seal between the electrochemical cell polymer-metal laminate packaging material, optional spacer, and surface-treated lead protruding from the package is formed.

2. The method of claim 1, wherein the lead material is aluminum.

3. The method of claim 1, wherein the polymer-metal laminate package comprises a sheet of aluminum foil between sheets of polyolefin.

4. The method of claim 1, wherein the spacers are composed of polyolefin.

5. The method of claim 1, wherein the spacers are composed of cross-linked polypropylene.

6. The method of claim 1, wherein said cell is a lithium ion battery cell.

7. The method of claim 1, wherein said metal lead surface-treatment comprises formation of a chromate conversion coating.

8. The method of claim 1, wherein said metal lead surface-treatment comprises formation of a phosphate conversion coating.

9. The method of claim 2, wherein said metal lead surface-treatment comprises anodization.

10. The method of claim 1, wherein said metal lead surface-treatment comprises a surface cleaning.

11. The method of claim 10 wherein said surface cleaning uses sodium hydroxide as a cleaning agent.

12. A polymer-metal laminate packaged electrochemical cell, comprising:
an electrochemical cell structure having a surface-treated metal lead connected to an electrode and projecting from said structure, wherein said surface-treated lead has at least one of increased hydrophobicity and polymer adhesion strength relative to an untreated lead of like composition; and
a polymer-metal laminate package enclosing said structure; and
optionally, polymeric spacers interposed between the lead and the polymer-metal laminate cell package;
wherein said packaged cell has a hermetic seal between the electrochemical cell polymer-metal laminate packaging material and the surface-treated lead protruding from the package.

13. The cell of claim 12, wherein the lead material is aluminum.

14. The cell of claim 12, wherein the polymer-metal laminate package comprises a sheet of aluminum foil between sheets of polyolefin.

15. The cell of claim 12, wherein the spacers are composed of polyolefin.

16. The cell of claim 12, wherein the spacers are composed of cross-linked polypropylene.

17. The cell of claim 12, wherein said cell is a lithium ion battery cell.

18. The cell of claim 12, wherein said metal lead surface-treatment comprises a chromate conversion coating.

19. The cell of claim 12, wherein said metal lead surface-treatment comprises a phosphate conversion coating.

20. The cell of claim 13, wherein said metal lead surface-treatment comprises anodization.

21. The cell of claim 12, wherein said metal lead surface-treatment comprises a surface cleaning.

22. An electrochemical cell current collector structure, comprising:
a metallic current collector;
a surface-treated metal lead conductively bonded to said current collector, said surface-treated lead having at least one of increased hydrophobicity and polymer adhesion strength relative to an untreated lead of like composition.

23. The structure of claim 22, wherein said lead material is aluminum.

24. The structure of claim 22, wherein said current collector material is aluminum.

25. The structure of claim 23, wherein said metal lead surface-treatment comprises a chromate conversion coating.

26. The structure of claim 25, wherein said chromate conversion coating has a golden color.

27. The method of claim 7, wherein the thickness of said chromate conversion coating is between about 2 and 30 Angstroms.

28. The method of claim 7, wherein the thickness of said chromate conversion coating is between about 2 and 5 Angstroms.

29. The method of claim 7, wherein the thickness of said chromate conversion coating is about 3 Angstroms.

30. The method of claim 7, wherein the thickness of said chromate conversion coating produces a golden color on an aluminum metal lead surface.

31. The cell of claim 18, wherein the thickness of said chromate conversion coating produces a golden color on an aluminum metal lead surface.

32. The method of claim 1 wherein the treated lead has a peel strength of greater than twenty-five pounds when laminated to cross-linked polypropylene.

33. The cell of claim 12 wherein the treated lead has a peel strength of greater than twenty-five pounds when laminated to cross-linked polypropylene.
